(19) United States
(12) Patent Application Publication
(10) Pub. No.: US 2004/0021312 A1
(43) Pub. Date: Feb. 5, 2004

(54) Security label

(76) Inventors: Timothy M. Dietz, Mendota Heights, MN (US); Sithya S. Khieu, Eden Prairie, MN (US); Mark D. Weigel, Hugo, MN (US)

Correspondence Address: 3M INNOVATIVE PROPERTIES COMPANY, PO BOX 33427, ST. PAUL, MN, 55133-3427, US

(21) Appl. No.: 10/211,081

(22) Filed: Aug. 2, 2002

(51) Int. Cl. B42D 15/00

(52) U.S. Cl. 283/81

(57) ABSTRACT

The invention relates to adhesive security labels that indicate tampering.

### FIELD OF THE INVENTION

The invention relates to adhesive security labels that indicate tampering.

### BACKGROUND OF THE INVENTION

Security continues to be important in various industries including the transportation industry, for instance, the airline industry. Security management of all items being placed on and taken off an airliner is important for passenger safety in the airline industry. For example, food carts are typically transferred on and off aircraft after every flight. The food carts are loaded with supplies and may be stored off of the aircraft for various periods of time. Currently, sealing tape is applied over the door seam and the adjacent surfaces of the food cart. Upon removal of the tape, the tape leaves a residue and appears distorted as means of indicating tampering. However, the adhesive residue of certain sealing tapes used for this purpose is difficult to remove and builds up over time and affects the appearance of the cart.

### SUMMARY OF THE INVENTION

In one aspect, the invention provides a method of making an article tamper evident. The method comprises the steps of applying an adhesive security label to an article wherein the adhesive security label has an adhesion to the article, the adhesive security label comprising a polymeric backing material having a yield point and having an adhesive on the backing material, wherein the security label would at least exhibit a permanent deformation upon application of sufficient force. The security label would indicate tampering by either its permanent deformation, and/or by being partially or completely removed from the article. In one embodiment, the adhesive is removable from the article without leaving substantial adhesive residue.

In another aspect, the invention provides a method of designing a tamper evident adhesive security label for a particular article. This method comprises the steps of selecting an adhesive that provides an adhesion to a surface of the article; selecting a polymeric backing material having a yield point and that bonds to the selected adhesive such that the backing material and the adhesive will not separate when subject to applied force that is lower than the force required to reach the yield point of the backing material; configuring said backing material, if required, such that the applied force required to reach the yield point is substantially the same or less than an applied force to remove the adhesive from the surface of the article; and bonding the selected adhesive to the backing material.

### BRIEF DESCRIPTION OF THE DRAWINGS

FIG. 1 shows a cross-section of one embodiment of a security label.

FIG. 2 shows a plan view of one configuration of a security label.

FIG. 3 shows a process flow diagram for making a security label for a particular article.

### DETAILED DESCRIPTION OF THE PREFERRED EMBODIMENTS

In general, the method of the invention provides a quick, easy, and reliable means to indicate whether a surface of an article or an article has been tampered with. Simply, a specifically designed permanently deformable security label, for example, in the form of a strip, is bonded to the surface of the article to be protected. Upon attempted removal using an applied force, the security label would be permanently deformed, for example, stretched, and optionally removed, both cases indicating tampering. A method for designing such a security label is described below.

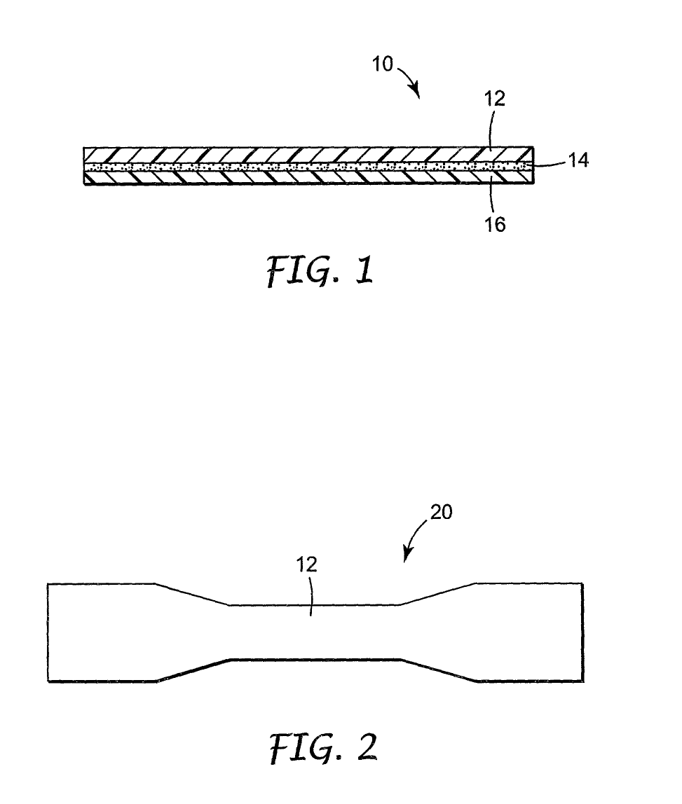

FIG. 1 shows a cross-section of one embodiment of a security label that permanently deforms when a force is applied. Security label 10 comprises or consists essentially of a backing 12 made from a material that has a yield point and an adhesive 14 on the backing. The security label 10 also provides an optional carrier layer 16. As shown in FIG. 2, a security label 20 may be in the shape of a “dogbone” showing one embodiment of how the cross-sectional area of the security label may be configured to achieve the desired force required to indicate tampering.

Useful polymeric backing materials are those that have a yield point, that is, a point at which the polymeric material is permanently deformed after a sufficient force or stress is applied. In other words, a “yield point” is the point at which, after an initial applied stress, appreciable elongation or yield in a material is obtained without the application of comparable additional stress. A material stressed beyond its yield point will have permanent deformation. Typically, the backing material is in the form of a film. Examples of materials that have a yield point are polyethylene, polypropylene, plasticized polyvinyl chloride, and terpolymers of vinylidine fluoride, hexafluoropropylene, and tetrafluoroethylene sold under the designation “THV 500”, available from 3M Company, St. Paul, Minn., and the like. Backing thickness generally ranges from about 0.5 to about 50 mil and may be any whole or fractional thickness between 0.5 and 50 mil.

Optionally, the backing material could be printable, that is, capable of receiving an image. The backing material may inherently be an image receiving medium or optionally coated with an image receiving coating as is known in the art of image receptors.

A suitable adhesive is an adhesive that forms a bond with the surface of the article that one wishes to make tamper evident. The adhesive should have adhesion strength to the article surface and a backing that will withstand an amount of force required for the security label to yield, without being separated from the surface of the article of the backing material. In some applications, the adhesive should also be easily removable from the surface of the article without leaving a residue on the article to be protected.

The adhesive selected may be pressure sensitive, hot melt, curable, thermoset, contact, thermoplastic, crosslinking, or any combination of these. Specific examples include acrylics, epoxies, urethanes, amides, natural or synthetic rubbers, olefins, cyanoacrylates, silicones, and the like.

The security labels may optionally include a carrier layer. The carrier layer typically protects the polymeric backing material from un-intentional distortion during handling or packaging of the adhesive-coated backing. Typically, the carrier layer would be comprised of a material having a higher modulus than that of the polymeric backing material. The carrier layer may be removably attached to the backing layer by an adhesive, static charge, and the like. Typical carrier layer materials include those made from or comprising polyester, paper, and the like.

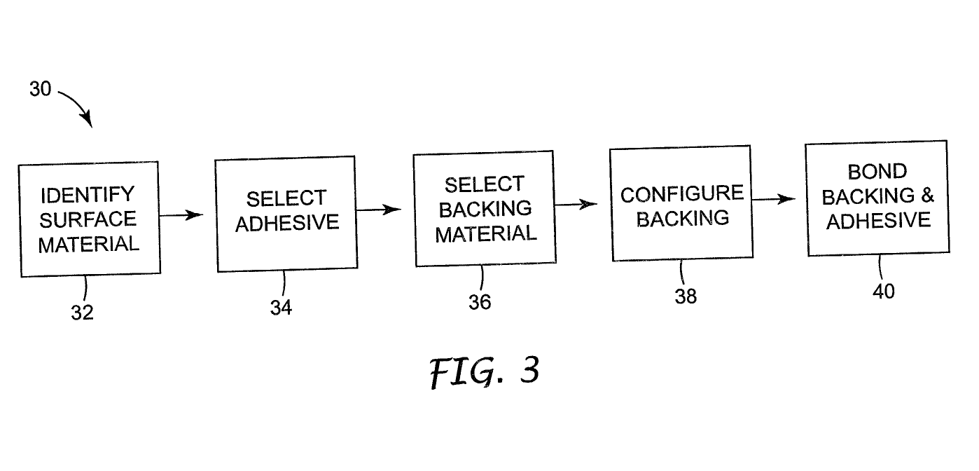

FIG. 3 shows a flow diagram 30 of a process to design a security label for a particular surface. A surface material is identified 32; a suitable adhesive is selected 34; a material that permanently deforms under an applied stress is selected 36; and a backing configuration of the backing is selected 38. The backing material is bonded to the adhesive 40.

The material of the article that one desires to apply a security label is identified. For example, the article surface may be plastic, metal, wood, glass, ceramic, masonry, painted, fabric, wallboard, and the like.

A suitable adhesive is selected with the article surface material in mind. For a particular article, a “suitable” adhesive is an adhesive that has an adhesion to the article surface that will remain substantially adhered to the surface and the backing material at least until the backing material reaches its yield point. Different adhesives may be applied to the surface of interest and then adhesion values to the surface may be measured and evaluated. The same testing may be performed with respect to the adhesion between the adhesive and the backing material. Typically, an adhesive that adheres well enough to the surface of the article such that the yield point of the backing is attained, yet does not adhere to such an extent that it becomes difficult to remove from the surface of the article is desirable.

The step of selecting a material that permanently deforms or yields under an applied stress may be performed simply by selecting polymeric materials, for example, polymer films, and applying a stress to them and noting whether they have a yield point, that is, the material permanently deforms after applying stress or stretching it. The yield point of the backing material for a security label should be attainable by mild to moderate stress applied by a person. Other criteria for the backing material include cost, adhesion to the adhesive, modulus, and the like.

Once a material having a yield point is selected, a backing configuration that permanently deforms at a desired applied force is selected. One means of selecting such a configuration is to cut a piece of the backing material having a certain cross-sectional area (thickness and width) and then measuring the force required to permanently deform that sample. Then, the shape and/or thickness of the backing material can be changed to achieve the yield point that matches the desired yield force. For example, increasing the cross-sectional area of the sample will likely increase the force required for the material to reach its yield point, while decreasing the cross-sectional area will likely decrease the amount of force needed to reach the yield point. The cross-sectional area may be changed by increasing or decreasing the width and/or thickness of the sample. Thus, one could construct correlation charts for each particular backing material that may be of interest.

### EXAMPLES

A sample of stretch-wrap film (HW-1570, available from AEP Industries, Inc.,) was laminated to a layer of 9472FL Acrylic PSA Transfer Adhesive (0.005 inch thick), available from 3M Company. A carrier layer (FET 615 Transfer Tape, available from American Biltrite Inc., Wellesley Hills, Mass.) was laminated to the other surface of the stretch-wrap film. The laminate was cut into 1×4 inch strips. A strip was applied to an aluminum panel and the carrier layer was removed. The resulting security label yielded upon attempted removal and the security label was permanently distorted. Attempts to reapply the distorted label were unsuccessful.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of making an article tamper evident comprising the step of:
applying an adhesive security label to an article, wherein the adhesive security label has an adhesion to the article, the adhesive security label comprising a polymeric backing material having a yield point and having an adhesive on the backing film, wherein the security label would at least exhibit a permanent deformation upon application of sufficient force.

2. A method of designing a tamper evident adhesive security label for a particular article comprising the steps of:
selecting an adhesive that provides an adhesion to a surface of the article;
selecting a polymeric backing material having a yield point and that bonds to the selected adhesive such that the backing material and the adhesive will not separate when subject to applied force that is lower than the force required to reach the yield point;
configuring said backing material having a thickness, width, and length such that the applied force required to reach the yield point is substantially the same or less than an applied force to remove the adhesive from the surface of the article; and
bonding the selected adhesive to the backing material.

3. The method of claim 1, wherein the adhesive is cleanly removable from a surface of the article.

4. The method of claim 1, wherein the backing material comprises polyethylene, polypropylene, plasticized polyvinyl chloride, a terpolymer of vinylidine fluoride, hexafluoropropylene, and tetrafluoroethylene, and combinations thereof.

5. The method of claim 1, wherein the adhesive comprises

6. The method of claim 1, wherein the security label consists essentially of a polymeric backing material having a yield point and having an adhesive on the backing film.

7. The method of claim 1 further comprising the step of applying a sufficient force to the security label to cause the backing material to reach its yield point or at least partial removal of the security label from the article.

8. The method of claim 1, wherein the article is part of an aircraft.

9. The method of claim 1, wherein the article is a beverage or food cart.

10. The method of claim 1, wherein the article is a cabinet, drawer, door, refrigerator, electrical panel, alarm system, luggage, or oven.

11. The method of claim 1, wherein the security label is placed over a door or drawer seam.

12. The method of claim 1, wherein the force required to reach the yield point of the backing material is less than 5 pounds force.

13. The method of claim 1, wherein the force required to reach the yield point of the backing material is greater than 0.01 pounds force.

14. The method of claim 2, wherein the step of configuring the backing material includes decreasing the cross-sectional area of at least a portion of the backing material.

15. The method of claim 2, wherein the step of configuring the backing material includes decreasing the thickness of the backing material.

16. The method of claim 2, wherein the step of configuring the backing material includes increasing the thickness of the backing material.

17. The method of claim 2, wherein the step of configuring the backing material includes increasing the width of the backing material over at a least a portion of its length.

18. The method of claim 2, wherein the step of configuring the backing material includes decreasing the width of the backing material over at least a portion of its length.

19. The method of claim 2, wherein the step of selecting an adhesive that provides an adhesion to the surface includes applying a plurality of adhesives to the surface and measuring each adhesive's adhesion to the surface.

20. The method of claim 2, wherein the step of selecting a polymeric backing material includes measuring the yield point of each of a plurality of backing materials.

21. The method of claim 2, wherein the step of bonding the selected adhesive to the backing material comprises lamination.
